(19) United States
(12) Patent Application Publication
(10) Pub. No.: US 2002/0079316 A1
(43) Pub. Date: Jun. 27, 2002

(54) Pan liner

(76) Inventors: Michael L. Greenfield, South Windsor, CT (US); Lawrence Greenfield, West Hartford, CT (US)

Correspondence Address: CANTOR COLBURN, LLP, 55 GRIFFIN ROAD SOUTH, BLOOMFIELD, CT, 06002

(21) Appl. No.: 10/000,948

(22) Filed: Oct. 24, 2001

Related U.S. Application Data
(60) Provisional application No. 60/242,972, filed on Oct. 24, 2000.

(51) Int. Cl. A47J 27/00; A47J 36/00; A47J 37/01

(52) U.S. Cl. 220/573.4

(57) ABSTRACT

A contoured pan liner and method of making a pan liner is provided, the pan liner including a first liner side panel having a first upper edge; a second liner side panel having a second upper edge; and at least one seam joining the first and second side panels, the first side panel, second side panel and at least one seam forming an interior region having an opening along the first and second upper edges, and wherein at least a portion of the at least one seam defines an arcuate path along at least a lower portion of the interior region.

### CROSS REFERENCE TO RELATED APPLICATIONS

The present application claims the priority of U.S. Provisional Application Serial No. 60/242,972, filed Oct. 24, 2001, the entire contents of which are specifically incorporated herein by reference.

### FIELD

The invention relates to a liner for a pan and more particularly to a specially shaped bag used to line a food service pan.

### BACKGROUND

The food preparation industry relies heavily on non-disposable cookware for both hot and cold food preparation. Such cookware is typically used, re-used, scrubbed and washed several times during a workday. In fact, many restaurants maintain a staff of employees whose primary responsibilities are scrubbing and washing such cookware. Many restaurants consider the expenses associated with hiring and maintaining the staff of employees responsible for scrubbing, with purchase of cleaning supplies and hot water, with maintaining a scrubbing station within the restaurant, and with waste caused by either scorching of the food, lack of convenient storage or food which cannot easily be removed from the edges of the cookware to be necessary and unavoidable expenses.

What is needed in the art is a low cost solution to the problems associated with cleaning soiled cookware as they are laid out above.

### SUMMARY

The present contoured pan liner overcomes and alleviates the above and other problems in the art by providing a first liner side panel having a first upper edge; a second liner side panel having a second upper edge; and at least one seam joining the first and second side panels, the first side panel, second side panel and at least one seam forming an interior region having an opening along the first and second upper edges, and wherein at least a portion of the at least one seam defines an arcuate path along at least a lower portion of the interior region.

In an exemplary embodiment, the liner is generally contoured to fit within an article of cookware. In another exemplary embodiment, the liner is substantially contoured to the shape of an article of cookware. In another exemplary embodiment, at least two seams provided along an interior region of the liner generally trace arcuate paths along at least a lower portion of the interior region.

Further, in another exemplary embodiment, the liner comprises a non-heat sealable temperature resistant polyester as an outer laminate layer and a heat sealable polyolefin, such as a polyethylene or polypropylene, as an inner laminate layer.

### BRIEF DESCRIPTION OF THE DRAWINGS

Referring now to the drawings wherein like elements are numbered alike in the several FIGURES:

FIG. 1 is a perspective view of an exemplary embodiment of a contoured pan liner;

FIG. 2 is a perspective view of an exemplary embodiment of a contoured pan liner in position within an exemplary pan;

FIG. 3 is a perspective view of another exemplary embodiment of a contoured pan liner; and

FIG. 4 is a perspective view of another exemplary embodiment of a contoured pan liner.

### DETAILED DESCRIPTION

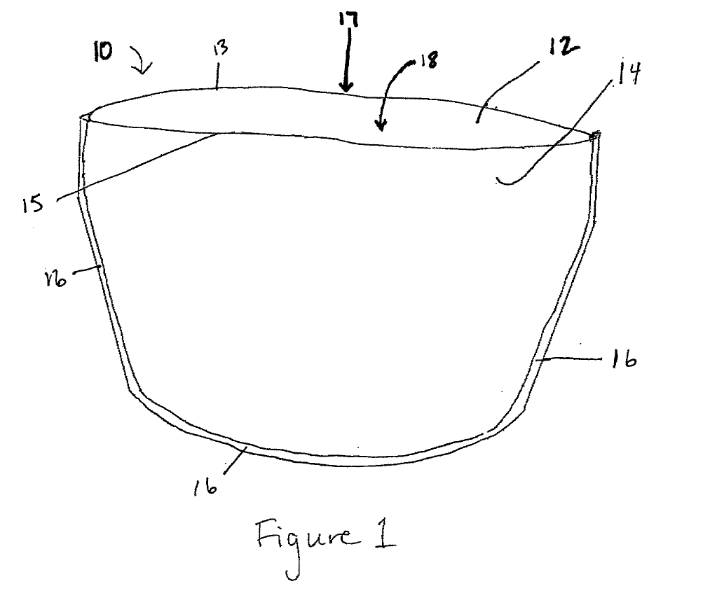

Referring to FIG. 1, an exemplary embodiment of a contoured pan liner is shown generally at 10. The exemplary contoured pan liner comprises first and second side panels 12, 14 sealed along a seam 16. The panels 12, 14 are illustrated as being of similar size and shape, such that the contoured pan liner is generally symmetric with respect to the seam 16. An interior region 18 is defined by the first and second side panels 12, 14 and the seam 16. The upper edges 13, 15 of the first and second panels 12, 14 define an opening 17 in the liner. In the illustrated embodiment, the sealed contoured seam 16 extends in a continuous arcuate path around the interior region 18 of panels 12, 14. The seals may be formed by any method known in the art, but are preferably heat-sealed.

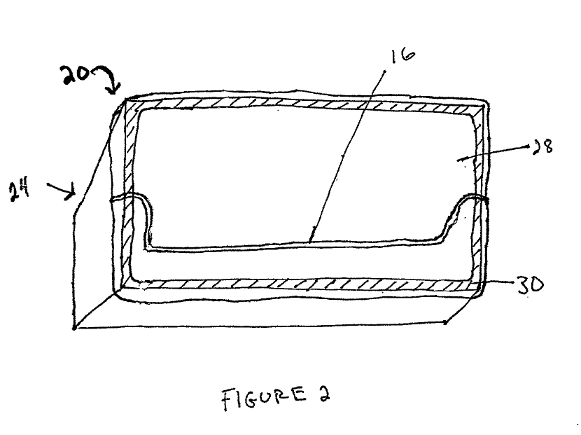

Referring now to FIG. 2, an exemplary contoured pan liner is generally shown at 20 disposed within a pan, shown generally at 24. The contoured seam 16, extends from within the pan 24, up the inner sides 26 (not shown), 28 of the pan 24, and over the top edge 30 of the pan 34. Thus, the upper edges 13, 15 of the first and second side panels 12, 14 are illustrated as configured to engage the top of the pan 34.

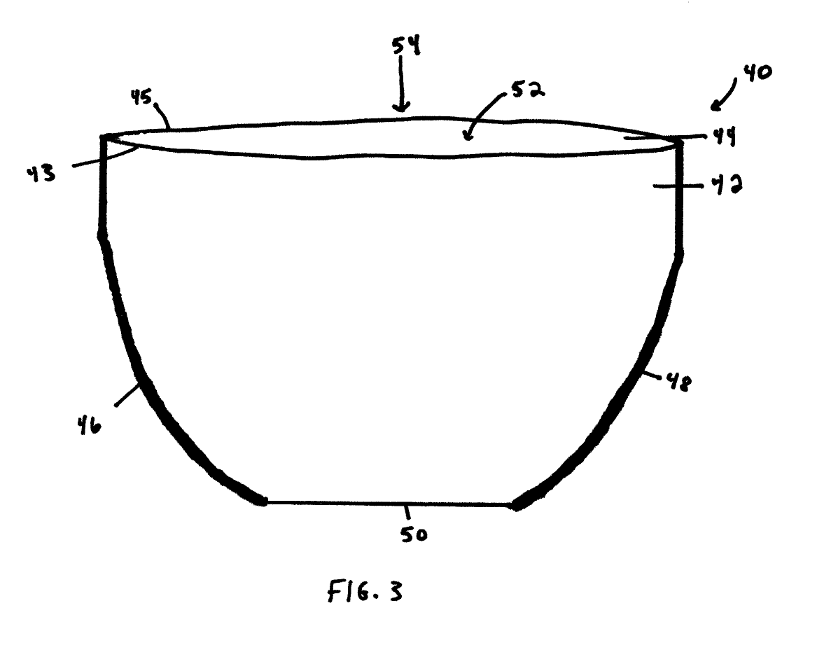

With reference to FIG. 3, another exemplary embodiment of a contoured pan liner is illustrated generally at 40. In the illustrated embodiment, first and second panels 42, 44 are sealed along first and second seams 46, 48 and along a lower fold line 50. The first and second panels 42, 44, first and second seams 46, 48 and lower fold line 50 define an interior region, shown generally at 52. First and second upper edges 43, 45 of first and second panels 42, 44 define an opening, shown generally at 54.

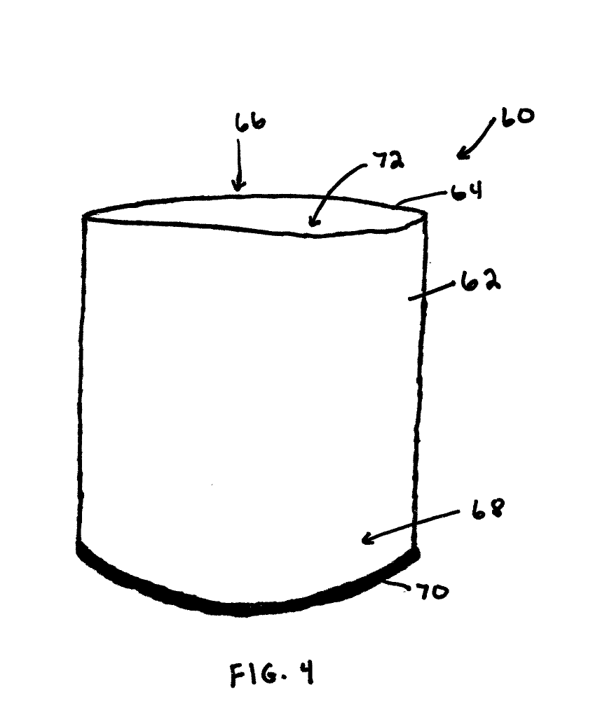

With reference to FIG. 4, another exemplary embodiment of a contoured pan liner is illustrated generally at 60. The exemplary contoured pan liner comprises a tube 62 of liner material having an upper edge 64 defining an opening, shown generally at 66. The tube is sealed at a lower end portion 68 by a seam 70. The seam 70 and the tube 62 define an interior region, shown generally at 72. The seam 70 traces a generally arcuate path along a lower portion of the interior space 72.

In one exemplary embodiment, the materials employed for construction of the pan liner include plastic laminates. That is, the panels comprise at least two layers of plastic in which may be joined or laminated by conventional methods. In one embodiment, the outer layer is a non-heat sealable material capable of resisting sustained temperatures of up to about 200 degrees Fahrenheit, such as those temperatures which are used for reheating of foods and service presentation of foods, rather than those temperatures required for cooking of foods. In another exemplary embodiment, the outer layer is a non-heat sealable material capable of resisting sustained temperatures of up to and above 400 degrees Fahrenheit, such as the temperatures which may typically be encountered in the cooking of foods. In another exemplary embodiment, the outer layer is a non-heat sealable, low to high temperature, heat resistant material, such as a polyester material. In another exemplary embodiment, the outer laminate layer is a material similar to those types of heat resistant materials sold under the trade name Mylar.

In another embodiment, the inner layer is heat sealable material that will not degrade in low to high temperature environments and that is safe for food contact. The heat sealable materials of the inner layer may provide an airtight and water tight barrier along the seams of the pan liner. Such inner layer also need not directly contact the heated source, and as such it may be a material having a lower temperature resistance (and thus, lower cost) than the outer layer. In one embodiment, the inner layer is a heat-sealable polyolefin material. In another embodiment, the inner layer is a polypropylene or polyethylene material.

The liner, when expanded, defines an interior region, which provides a depth sufficient to fit into the bottom of a pan. The laminate construction and contour geometry provide the ability to neatly hold any remaining material when the liner is removed from the pan. In one embodiment, the dimensions of the interior region are such that when the pan liner is placed within a pan, the interior region is substantially contoured to the pan such that free space between the liner and the pan is minimized and such that bunching of the material (where the material is too large for the pan) is minimized. This close fit provides for maximum volume of the liner and pan system and clean operation of the system for food service.

The illustrated seaming configurations illustrated by the exemplary embodiment as shown in FIGS. 1-4, wherein at least one seam is provided and wherein the at least one seam defines an arcuate path along at least a lower portion of the interior region, also plays an important role in minimizing waste by eliminating troublesome comers along the seams.

FIG. 1 illustrates an exemplary liner independently from the pan. As can be seen, the contoured seam 16 traces a generally arcuate path along a lower portion of the interior space 18. Thus, food cannot accrue in areas inaccessible to a spoon or other instrument. This exemplary liner not only eliminates waste by virtue of the fully expanded interior space 18 geometry, but also provides for easy food removal from the liner whether the liner is fully open or partially collapsed.

Lining such cookware advantageously provides a sanitary cooking and/or serving surface. Lining pans is an efficient means of food service as it removes the need for washing pans, eliminating the cost of washing and the time a pan is made unavailable while it is being washed. Pans can be immediately re-lined and reused. The present pan liner also provides an advantageous seaming configuration, including an arcuate seam path along at least a lower portion of the interior region, for facilitating food removal whether the liner is expanded or partially collapsed. The present pan liner also advantageously provides a laminate material tailored to reduce costs and to provide exterior heat resistance coupled with interior sealing and food compatibility at elevated temperatures.

Although the invention has been shown and described with respect to exemplary embodiments thereof, it should be understood by those skilled in the art that various changes, omissions, and additions may be made thereto, without departing from the spirit and scope of the invention.

I claim:

1. A contoured pan liner comprising:
a first liner side panel having a first upper edge;
a second liner side panel having a second upper edge; and
at least one seam joining the first and second side panels, the first side panel, second side panel and at least one seam forming an interior region having an opening along the first and second upper edges, and wherein at least a portion of the at least one seam defines an arcuate path along at least a lower portion of the interior region.

2. The contoured pan liner in accordance with claim 1, wherein the opening is configured to engage the top edge of a pan.

3. The contoured pan liner in accordance with claim 1, wherein the liner is symmetric with respect to the at least one first seal.

4. The contoured pan liner in accordance with claim 1, further comprising a second seam joining the first and second side panels, the second seam defining an arcuate path along at least a lower portion of the interior region.

5. The contoured pan liner in accordance with claim 1, wherein the liner is contoured such that the liner is configured to be substantially coextensive with the internal dimensions of a pan.

6. The contoured pan liner in accordance with claim 1, wherein the panels comprise a non-heat sealable temperature resistant polyester outer laminate layer and a heat sealable polyolefin inner laminate layer.

7. The contoured pan liner in accordance with claim 6, wherein the inner laminate layer is a polyethylene or polypropylene material.

8. The contoured pan liner in accordance with claim 4, further comprising a lower fold line between first and second seams.

9. The contoured pan liner in accordance with claim 1, further comprising a fold line on at least a portion of the liner between the upper edges and the at least one seam.

10. A temperature resistant, food compatible pan liner, comprising:
a first liner side panel having a first upper edge;
a second liner side panel having a second upper edge, the second side panel sealed to the first side panel along at least one seam, the first side panel, second side panel and at least one seam forming an interior region having an opening along the first and second upper edges, and wherein at least one of the first and second side panels comprises a plastic laminate, comprising a heat sealable polyolefin inner layer and a non-heat sealable, temperature resistant material exterior layer.

11. The temperature resistant, food compatible pan liner in accordance with claim 10, wherein the opening is configured to engage the top edge of a pan.

12. The temperature resistant, food compatible pan liner in accordance with claim 10, wherein the liner is symmetric with respect to the at least one first seal.

13. The temperature resistant, food compatible pan liner in accordance with claim 10, further comprising a second seam joining the first and second side panels, the second seam defining an arcuate path along at least a lower portion of the interior region.

14. The temperature resistant, food compatible pan liner in accordance with claim 10, wherein the liner is contoured such that the liner is configured to be substantially coextensive with the internal dimensions of a pan.

15. The temperature resistant, food compatible pan liner in accordance with claim 13, further comprising a lower fold line between first and second seams.

16. The temperature, resistant, food compatible pan liner in accordance with claim 10, further comprising a fold line on at least a portion of the liner between the upper edges and the at least one seam.

17. A contoured pan liner, comprising:
a tube of a plastic laminate liner material; and
at least one seam on at least a bottom portion of the tube, wherein the tube and the at least one seam defines an interior region, and wherein at least a portion of the at least one seam defines an arcuate path along at least a lower portion of the interior region.

18. The contoured pan liner in accordance with claim 17, wherein the liner is symmetric with respect to the at least one first seam.

19. The contoured pan liner in accordance with claim 17, further comprising a second seam defining an arcuate path along at least a lower portion of the interior region.

20. The contoured pan liner in accordance with claim 17, wherein the liner is contoured such that the liner is configured to be substantially coextensive with the internal dimensions of a pan.

21. The contoured pan liner in accordance with claim 17, wherein the tube comprises a non-heat sealable temperature resistant polyester outer laminate layer and a heat sealable polyolefin inner laminate layer.

22. The contoured pan liner in accordance with claim 21, wherein the inner layer is a polyethylene or polypropylene material.

23. The contoured pan liner in accordance with claim 19, further comprising a lower fold line between first and second seams.

24. The contoured pan liner in accordance with claim 17, further comprising a fold line on at least a portion of the liner between an upper edge of the tube and the at least one seam.

25. A method of manufacturing a pan liner, comprising:
laminating a heat sealable polyolefin inner layer and a non-heat sealable, temperature resistant material exterior layer to form at least one panel;
forming an interior region between two panel surfaces, comprising forming at least one seam, wherein the at least one seam is arcuate along a path on at least a lower portion of the interior region.

26. The method of manufacturing a pan liner in accordance with claim 25, wherein the at least one panel is a tubular panel, and wherein the at least one seam is formed at one end of the tubular panel to form the interior region.

27. The method of manufacturing a pan liner in accordance with claim 25, wherein the at least one panel is folded onto itself, and wherein the at least one seam is formed on a portion of the folded panel to form the interior region.

28. The method of manufacturing a pan liner in accordance with claim 25, wherein a first and second panels are stacked, and wherein the at least one seam is formed on the stacked first and second panels to form the interior region.

29. The method of manufacturing a pan liner in accordance with claim 25, wherein at least one seam is heat sealed.
